(19) United States
(12) Patent Application Publication
(10) Pub. No.: US 2020/0063827 A1
(43) Pub. Date: Feb. 27, 2020

(54) IN-LINE BALANCE SHAFT SYSTEM FOR INTERNAL COMBUSTION ENGINES

(71) Applicant: GM GLOBAL TECHNOLOGY OPERATIONS LLC, Detroit, MI (US)

(72) Inventors: Alessio Courtial, Torino (IT); Giuseppe Grioli, Torino (IT); Paolo Marocco, Leini (IT); Giuliano Sperlinga, Ottaviano (IT)

(73) Assignee: GM GLOBAL TECHNOLOGY OPERATIONS LLC, Detroit, MI (US)

(21) Appl. No.: 16/113,617

(22) Filed: Aug. 27, 2018

(51) Int. Cl. F16F 15/26; F16F 15/28; F02B 75/20; F16H 1/28; F16H 1/46

(52) U.S. Cl. CPC F16F 15/264; F16F 15/283; F02B 2075/1816; F16H 1/28; F16H 1/46; F02B 75/20

(57) ABSTRACT

An internal combustion engine includes a crankshaft including an outer crankshaft gear and an in-line balance shaft system coupled to the crankshaft. The in-line balance shaft system is configured to balance reciprocating inertial forces of the internal combustion engine, the in-line balance shaft system is configured to provide concurrent and counter-rotating balance forces. The in-line balance shaft system includes a planetary gear set coupled to the crankshaft. The planetary gear set is coupled to the outer crankshaft gear such rotation of the crankshaft drives the planetary gear set. The planetary gear set includes an input gear and an output gear. The input gear is coupled to the crankshaft such that rotation of the crankshaft causes rotation of the input gear.

### INTRODUCTION

The present disclosure relates to an internal combustion engine including an in-line balance shaft system.

Internal combustion engines are used, for example, by vehicles for propulsion. Alternatively, internal combustion engines may be used to provide power to other devices.

### SUMMARY

The present disclosure describes an in-line balance shaft system for balancing internal combustion engines. Specifically, the in-line balance shaft system is configured to balance reciprocating internal forces of the internal combustion engine, providing both concurrent and counter-rotating balance forces on the same shaft with less weight than other balance systems (which may be based on two shafts). Other balance systems include distribution mechanisms, such as a chain or a belt. The presently disclosed in-line balance shaft system does not include distribution mechanisms, such as a chain, a belt and/or tensioner. Further, the presently disclosed in-line balance shaft system has both concurrent and counter rotating balancing components on the same axis with a more compact packaging size than other balance systems (e.g., one shaft less) and is an overall lighter system than other balance systems. The presently disclosed in-line balance system may be assembled on a shorter shaft (as compared with other balance systems) and fastened to an engine block or other suitable stationary object, thus saving volume that would be dedicated to the rotating shaft. The torque distribution is embedded with the in-line balance shaft system. Therefore, no torque distribution mechanism, such as a belt, chain and/or tensioner, is needed.

In certain embodiments, the internal combustion engine includes a crankshaft including an outer crankshaft gear and an in-line balance shaft system coupled to the crankshaft. The in-line balance shaft system is configured to provide concurrent and counter-rotating balance forces to balance reciprocating inertial forces of the internal combustion engine. The in-line balance shaft system includes a planetary gear set coupled to the crankshaft. The planetary gear set is coupled to the outer crankshaft gear such that rotation of the crankshaft drives the planetary gear set. The planetary gear set includes an input gear and an output gear. The input gear is coupled to the crankshaft such that rotation of the crankshaft causes rotation of the input gear. The planetary gear set is configured to provide a 1:1 gear ratio between the input gear and the output gear such that the input gear and the output gear rotate at a same speed upon rotation of the crankshaft. The in-line balance shaft system includes a gear counterweight coupled to the output gear. The gear counterweight is configured to balance the crankshaft upon rotation of the crankshaft. The in-line balance shaft system includes a balance shaft gear, and the outer crankshaft gear is meshed with the balance shaft gear such that rotation of the crankshaft causes rotation of the balance shaft gear. The in-line balance shaft system includes a balance shaft coupled to the balance shaft gear such that the balance shaft rotates in unison with the balance shaft gear. The crankshaft includes a plurality of crankshaft counterweights. The crankshaft gear is coupled to at least one of the plurality of crankshaft counterweights such that the crankshaft gear rotates in unison with the plurality of crankshaft counterweights. The crankshaft rotates about a crankshaft axis.

The balance shaft rotates about a balancer axis. The crankshaft axis is offset from the balancer axis. The balancer axis is parallel to the crankshaft axis. The outer crankshaft gear is configured to rotate about the crankshaft axis. The balance shaft gear is configured to rotate about the balancer axis. The in-line balance shaft system further includes a shaft counterweight directly coupled to the balance shaft gear such that rotation of the balance shaft gear causes rotation of the shaft counterweight. The gear counterweight is directly coupled to the output gear. The input gear is a sun gear, the balance shaft is directly coupled to the sun gear such that rotation of the balance shaft causes rotation of the sun gear, and the sun gear is configured to rotate about the second rotational axis. The planetary gear set includes a first planet gear meshed with the sun gear such that rotation of the sun gear causes the first planet gear to orbit around the sun gear. The planetary gear set includes a planet carrier coupled to the first planet gear, the internal combustion engine includes an engine block. The planet carrier is coupled to the engine block such that the planet carrier remains stationary upon rotation of the sun gear and the first planet gear. The planetary gear set includes a second planet gear coupled to the first planet gear such that the first planet gear and the second planet gear rotate in unison. The output gear is a ring gear. The ring gear is meshed with the second planet gear such that rotation of the second planet gear causes rotation of the ring gear, thereby causing the sun gear and the ring gear to rotate in opposite directions. The gear counterweight is directly coupled to the ring gear to provide a counter-rotating balance force, and the ring gear is configured to rotate about the second rotational axis. The internal combustion engine is a 4-cylinder engine.

In certain embodiments, the internal combustion engine includes a crankshaft defining a crankshaft axis and including a first end portion and a second end portion opposite the first end portion. The second end portion is spaced apart from the first end portion along the crankshaft axis. The crankshaft is configured to rotate about the crankshaft axis. The internal combustion engine further includes an in-line balance shaft system coupled to the crankshaft. The in-line balance shaft system is configured to provide concurrent and counter-rotating balance forces to balance reciprocating inertial forces of the internal combustion engine. The in-line balance shaft system includes a first planetary gear set coupled to the first end portion of the crankshaft and a second planetary gear set coupled to the second end portion of the crankshaft such that the first planetary gear set and the second planetary gear set are spaced apart from each other along the crankshaft axis. Each of the first planetary gear set and the second planetary gear set includes an input gear and an output gear. The input gear is coupled to the crankshaft such that rotation of the crankshaft causes rotation of the input gear. Each of the first planetary gear set and the second planetary gear set is configured to provide a 1:1 gear ratio between the input gear and the output gear such that the input gear and the output gear rotate at a same speed upon rotation of the crankshaft. The in-line balance shaft system includes a gear counterweight coupled to the output gear, wherein the counterweight is configured to balance the crankshaft upon rotation of the crankshaft. The input gear is a sun gear, and the crankshaft is directly coupled to the sun gear such that rotation of the crankshaft causes rotation of the sun gear. Each of the first planetary gear set and the second planetary gear set includes a respective first planet gear meshed with the sun gear such that rotation of the sun gear causes the first planet gear to orbit around the sun gear.

The sun gear of each of the first planetary gear set and the second planetary gear set is configured to rotate about the crankshaft axis. The crankshaft includes a forwardmost end and a rearmost end opposite the forwardmost end, the first end portion includes the forwardmost end of the crankshaft. The second end portion includes the rearmost end of the crankshaft. The first planetary gear set is closer to the forwardmost end than to the rearmost end of the crankshaft. The second planetary gear set is closer to the rearmost end than to the forwardmost end of the crankshaft. The internal combustion engine is a 3-cylinder engine. Each of the first planetary gear set and the second planetary gear includes a planet carrier coupled to the first planet gear. The internal combustion engine includes an engine block. The planet carrier is coupled to the engine block such that the planet carrier remains stationary upon rotation of the sun gear and the first planet gear. Each of the first planetary gear set and the second planetary gear set includes a respective second planet gear coupled to the first planet gear such that the first planet gear and the second planet gear rotate in unison. The output gear is a ring gear. The ring gear is meshed with the second planet gear such that rotation of the second planet gear causes rotation of the ring gear, thereby causing the sun gear and the ring gear to rotate in opposite directions. The gear counterweight is directly coupled to the ring gear to provide a counter-rotating balance force.

In certain embodiments, the in-line balance shaft system is configured to be coupled to a crankshaft of an internal combustion engine and includes a planetary gear set coupled to the crankshaft. The planetary gear set includes a sun gear. The sun gear is coupled to the crankshaft such that rotation of the crankshaft causes rotation of the sun gear. The planetary gear set includes a ring gear. The planetary gear set is configured to provide a 1:1 gear ratio between the sun gear and the ring gear such that the sun gear and the ring gear rotate at a same speed upon rotation of the crankshaft. The in-line balance shaft system includes a gear counterweight coupled to the ring gear. The planetary gear set includes a first planet gear meshed with the sun gear such that rotation of the sun gear causes the first planet gear to orbit around the sun gear. The planetary gear set includes a second planet gear coupled to the first planet gear such that the first planet gear and the second planet gear rotate in unison. The ring gear is meshed with the second planet gear such that rotation of the second planet gear causes rotation of the ring gear, thereby causing the sun gear and the ring gear to rotate in opposite directions. The in-line balance shaft system includes a balance shaft gear configured to mesh with an outer crankshaft gear of the crankshaft such that rotation of the crankshaft causes rotation of the balance shaft gear. The in-line balance shaft system includes a balance shaft coupled to the balance shaft gear such that the balance shaft rotates in unison with the balance shaft gear. The in-line balance shaft system includes a shaft counterweight directly coupled to the balance shaft gear such that rotation of the balance shaft gear causes rotation of the shaft counterweight. The first counterweight mass is directly coupled to the ring gear to provide a counter-rotating balance force. The balance shaft is directly coupled to the sun gear such that rotation of the balance shaft causes rotation of the sun gear. The first counterweight mass is configured to balance the crankshaft upon rotation of the crankshaft. The planetary gear set includes a planet carrier coupled to the first planet gear. The planet carrier is configured to remain stationary upon rotation of the sun gear and the first planet gear. The in-line balance shaft system is configured to balance reciprocating inertial forces of the internal combustion engine. The in-line balance shaft system is configured to provide concurrent and counter-rotating balance forces.

The above features and advantages and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 is a schematic perspective view of a 4-cylinder internal combustion engine including a crankshaft and an in-line balance shaft system.

FIG. 2 is a schematic front view of the crankshaft and the in-line balance shaft system shown in FIG. 1.

FIG. 3 is a schematic, partial, perspective view of the crankshaft and the in-line balance shaft system shown in FIG. 1, taken around area A.

FIG. 4 is a schematic perspective front view of the in-line balance shaft system shown in FIG. 1.

FIG. 5 is a schematic perspective rear view of the in-line balance shaft system shown in FIG. 1.

FIG. 6 is a schematic, exploded perspective view of the in-line balance shaft system shown in FIG. 1.

FIG. 7 is a schematic, front sectional view of the of a planet carrier of the in-line balance shaft system shown in FIG. 1, taken along section line 7-7 of FIG. 6.

FIG. 8 is a stick diagram, illustrating the internal combustion engine of FIG. 1.

FIG. 9 is a schematic perspective view of a 3-cylinder internal combustion engine including a crankshaft and an in-line balance shaft system.

FIG. 10 is an exploded, partial, perspective view of the crankshaft and the in-line balance shaft system of FIG. 7.

FIG. 11 is a stick diagram, illustrating the internal combustion engine of FIG. 9.

### DETAILED DESCRIPTION

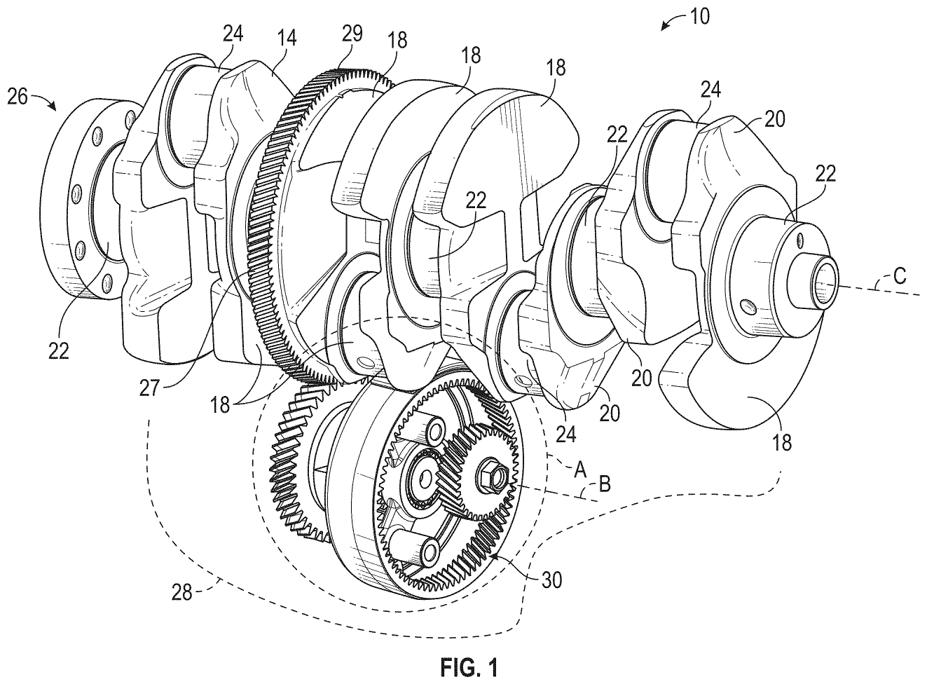

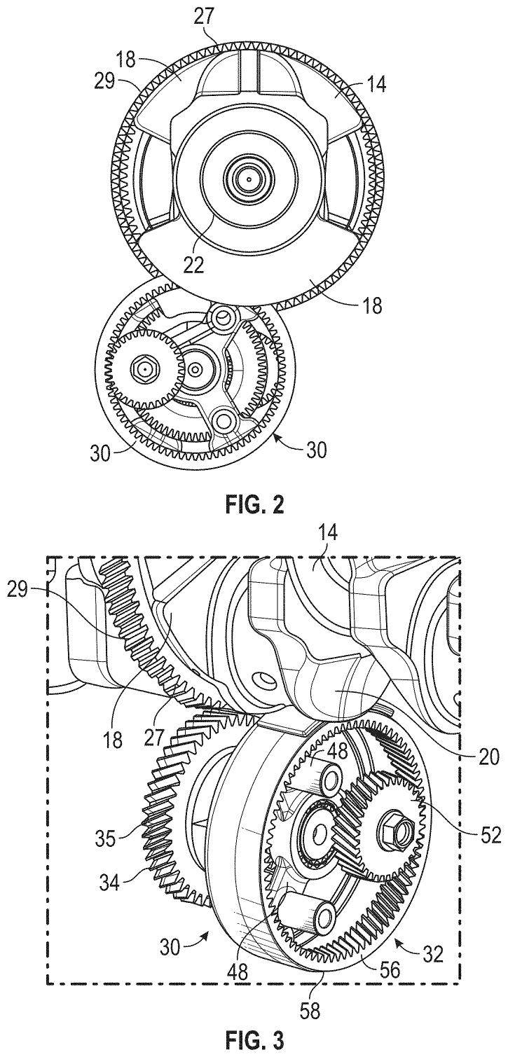

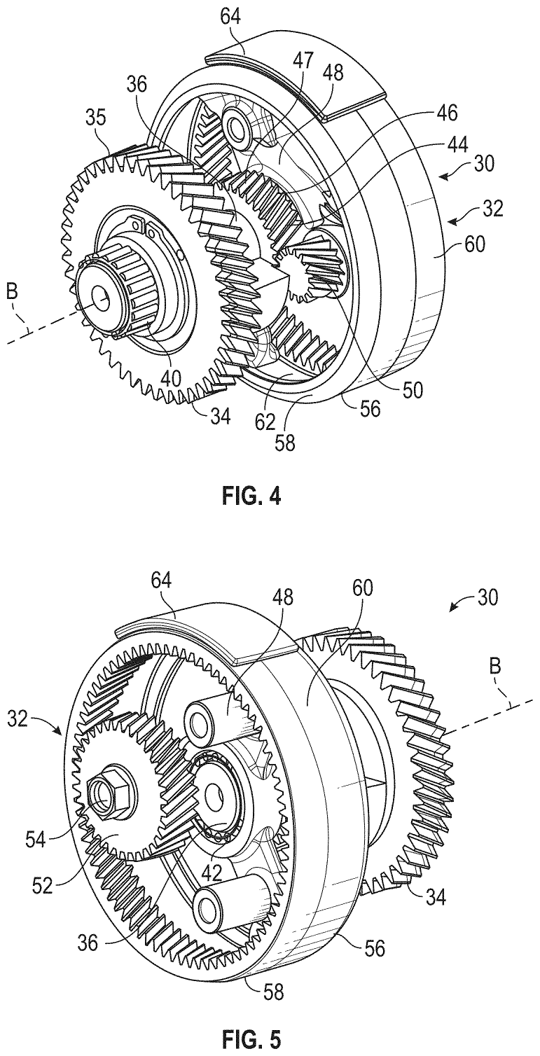

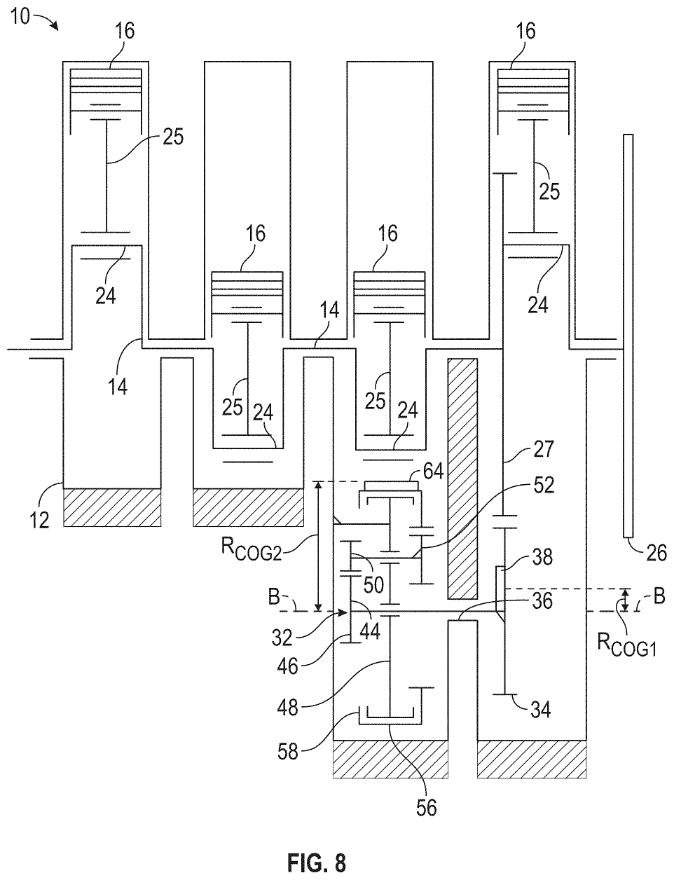

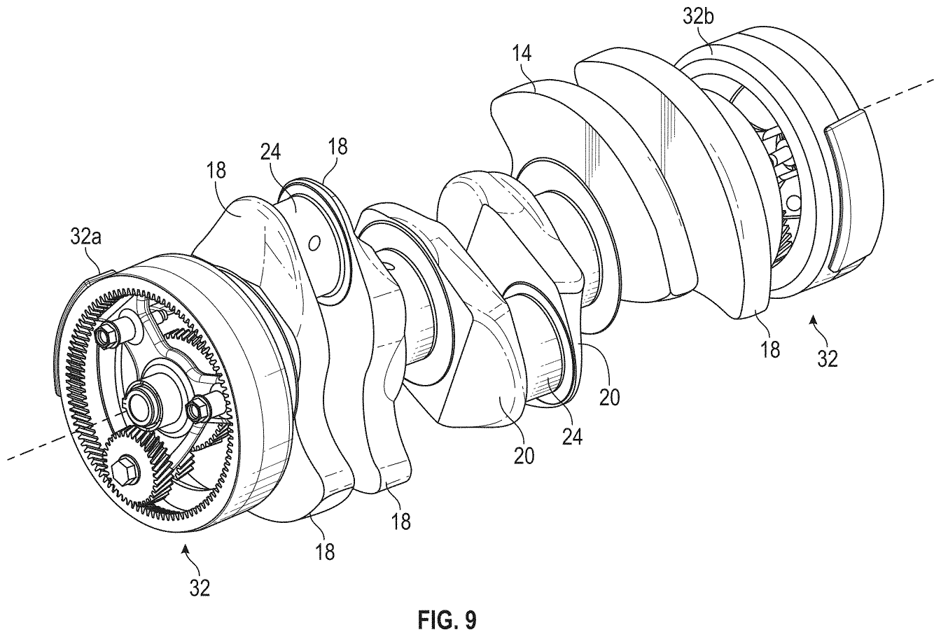

With reference to FIGS. 1-8, an internal combustion engine 10 may be used to propel a vehicle, such as a car, a truck, agricultural equipment, or other device suitable to transport objects and/or passengers. The internal combustion engine 10 includes an engine block 12 (FIG. 8), a crankshaft 14, and a plurality of pistons 16 (FIG. 8) coupled to the crankshaft 14. In the depicted embodiment, the internal combustion engine 10 may be a 4-cylinder engine.

The crankshaft 14 is elongated along a crankshaft axis C and is configured to rotate about the crankshaft axis C. In the depicted embodiment, the crankshaft 14 includes a plurality of crankshaft counterweights 18, a plurality of crank arms 20, a plurality of main bearing journals 22, a plurality of crank pins 24, and a flywheel mounting flange 26. Each crank pin 24 interconnects two of the crank arms 20. The internal combustion engine 10 further includes a plurality of connecting rods 25 (FIG. 8). Each connecting rod 25 interconnects one of the piston 16 to one of the crank pins 24 to enable the pistons 16 to reciprocate upon rotation of the crankshaft 14 about the crankshaft axis C. In the depicted embodiment, the internal combustion engine 10 may include solely four pistons 16. At least some of the main bearing journals 22 interconnect two of the crankshaft counterweights 18. The crankshaft 14 further includes an outer crankshaft gear 27 configured to rotate about the crankshaft axis C. The outer crankshaft gear 27 is part of the crankshaft 14 and therefore rotates in unison with the rest of the crankshaft 14. Further, the outer crankshaft gear 27 is directly coupled to one or more of the crankshaft counterweights 18 to enable the outer crankshaft gear 27 to rotate in unison with the rest of the crankshaft 14 about the crankshaft axis C. The outer crankshaft gear 27 includes a number of crankshaft teeth 29. The internal combustion engine 10 further includes an oil pan 28 for collecting oil.

The internal combustion engine 10 further includes an in-line balance shaft system 30 mechanically coupled to the crankshaft 14. In particular, the in-line balance shaft system 30 is mechanically coupled to the outer crankshaft gear 27. As such, torque is transmitted from the outer crankshaft gear 27 to the in-line balance shaft system 30. Therefore, rotation of the crankshaft 14 drives the in-line balance shaft system 30. The in-line balance shaft system 30 is configured to balance reciprocating inertial forces of the internal combustion engine 10. Moreover, the in-line balance shaft system 30 is configured to provide concurrent and counter-rotating balance forces. In the depicted embodiment, the in-line balance shaft system 30 may be entirely disposed within the oil pan 28.

With specific reference to FIGS. 3-6, the in-line balance shaft system 30 includes a planetary gear set 32 coupled to the crankshaft 14 through the outer crankshaft gear 27. The in-line balance shaft system 30 includes a balance shaft gear 34 that is meshed with the outer crankshaft gear 27 of the crankshaft 14. As such, rotation of the crankshaft 14 causes rotation of the balance shaft gear 34. The in-line balance shaft system 30 includes a balance shaft 36 directly coupled to the balance shaft gear 34. As such, the balance shaft 36 rotates in unison with the balance shaft gear 34. The in-line balance shaft system 30 further includes a shaft counterweight 38 directly coupled to the balance shaft 36 and the balance shaft gear 34 to balance the internal combustion engine 10. The balance shaft gear 34 includes a number of shaft teeth 35. The number of crankshaft teeth 29 is double the number of shaft teeth 35 to appropriately balance the internal combustion engine 10. In the depicted embodiment, the shaft counterweight 38 may be configured as a semicylindrical body to minimize the space occupied by the in-line balance shaft system 30. During rotation, the shaft counterweight 38 provides a concurrent rotating balancing force. Because the shaft counterweight 38 is solely coupled to one side of the balance shaft 36, the shaft counterweight 38 is considered an eccentric mass in relation to the balance axis B. The shaft counterweight 38 has a mass M_{C1}. The in-line balance shaft system 30 includes a first roller bearing 40 and a second roller bearing 42 coupled to the balance shaft 36. The first roller bearing 40 is disposed between the balance shaft 36 and the engine block 12 (FIG. 8) to allow rotation of the balance shaft 36 relative to the engine block 12.

The planetary gear set 32 includes an input gear 44 (which may be a sun gear 46) directly coupled to the balance shaft 36. As such, rotation of the balance shaft 36 causes rotation of the input gear 44 (e.g., sun gear 46) about the balancer axis B. In particular, the input gear 44 is press-fit or locked to the balance shaft 36. The balance shaft 36 and the input gear 44 are configured to rotate in unison. Generally, the input gear 44 is coupled to the crankshaft 14. As such, rotation of the crankshaft 14 causes rotation of the input gear 44. The planetary gear set 32 further includes a planet carrier 48 coupled to the balance shaft 36. The second roller bearing 42 is disposed between the planet carrier 48 and the balance shaft 36 to allow rotation of the balance shaft 36 relative to the planet carrier 48. The planet carrier 48 is coupled to the engine block 12. As such, the planet carrier 48 remains stationary upon rotation of the input gear 44 (e.g., sun gear 46). For instance, the planet carrier 48 may be fastened to the engine block 12 to provide load support. The planetary gear set 32 further includes a first planet gear 50 meshed with the input gear 44 (e.g., sun gear 46). As such, rotation of the input gear 44 (e.g., sun gear 46) causes the first planet gear 50 to orbit around the input gear 44 (e.g., sun gear 46). The input gear 44 (e.g., sun gear 46) has a number of input teeth 47. The first planet gear 50 is configured to orbit around the balancer axis B. The planetary gear set 32 includes a second planet gear 52 coupled to the first planet gear 50. As such, the first planet gear 50 and the second planet gear 52 rotate in unison. The second planet gear 52 is configured to orbit around the balancer axis B. In the depicted embodiment, a fastener 54 (e.g., a bolt) extends through the planet carrier 48 and directly couples the first planet gear 50 to the second planet gear 52. The first planet gear 50 has a number of first teeth 51, and the second planet gear 52 has a number of second teeth 53.

The planetary gear set 32 further includes an outer gear 56, such as a ring gear 58. The ring gear 58 is meshed with the second planet gear 52, thereby allowing the planetary gear set 32 to provide a 1:1 gear ratio between the input gear 44 (e.g., sun gear 46) and the output gear 56 (e.g., ring gear 58). As such, the input gear 44 and the output gear 56 rotate at a same speed upon rotation of the crankshaft 14. However, the input gear 44 and the outer gear 56 rotate in opposite directions upon rotation of the crankshaft 14. Both the input gear 44 (e.g, sun gear 46) and the output gear 56 (e.g., ring gear 58) are configured to rotate about the balancer axis B. The ring gear 58 defines an outer ring surface 60 and an inner ring surface 62 opposite the outer ring surface 60. The planetary gear set 32 includes a gear counterweight 64 directly coupled to the outer ring surface 60 of the ring gear 58. Accordingly, the gear counterweight 64 is configured to balance the crankshaft upon rotation of the crankshaft 14 by providing a counter rotating balancing force. The gear counterweight 64 may be fastened or welded to the outer ring surface 60 of the ring gear 58. Therefore, the gear counterweight 64 rotates in unison with the ring gear 58. It is contemplated that the gear counterweight 64 may be an integral part of the ring gear 58. In the depicted embodiment, the gear counterweight 64 may be configured as a curved plate. Because the gear counterweight 64 is disposed on the outer ring surface 60 of the ring gear 58, it is considered an eccentric mass in relation to the balancer axis B. The outer gear 56 (e.g., ring gear 58) has a number of gear teeth 59 extending from the inner ring surface 62 toward the balancer axis B. The gear counterweight 64 has a mass M_{C2}. To properly balance the internal combustion engine 10, the relationship between the gear counterweight 64 and the shaft counterweight 38 is characterized by the following equation:

M_{C1}·R_{COG1}=M_{C2}·R_{COG2}

where:

M_{C1} is the mass of the shaft counterweight 38;

M_{C2} is the mass of the gear counterweight 64;

R_{COG1} is a center of gravity radius of the shaft counterweight 38 that is measured from the balancer axis B to the center of gravity of the shaft counterweight 38; and

R_{COG2} is a center of gravity radius of the gear counterweight 64 that is measured from the balancer axis B to the center of gravity of the gear counterweight 64.

To properly balance the internal combustion engine 10, the relationship among the outer gear 56 (e.g., the ring gear 58), the input gear 44 (e.g., the sun gear 46), the first planet gear 50, and the second planet gear 52 is characterized by the following equation:

$$\frac{{N}_{1}}{{N}_{2}} = \frac{{N}_{4}}{{N}_{3}}$$

where:

N₁ is the number of input teeth 47 of the input gear 44 (e.g., sun gear 46);

N₂ is the number of first teeth 51 of the first planet gear 50;

N₃ is the number of second teeth 53 of the second planet gear 52; and

N₄ is the number of gear teeth 59 of the output gear 56 (e.g., ring gear 58).

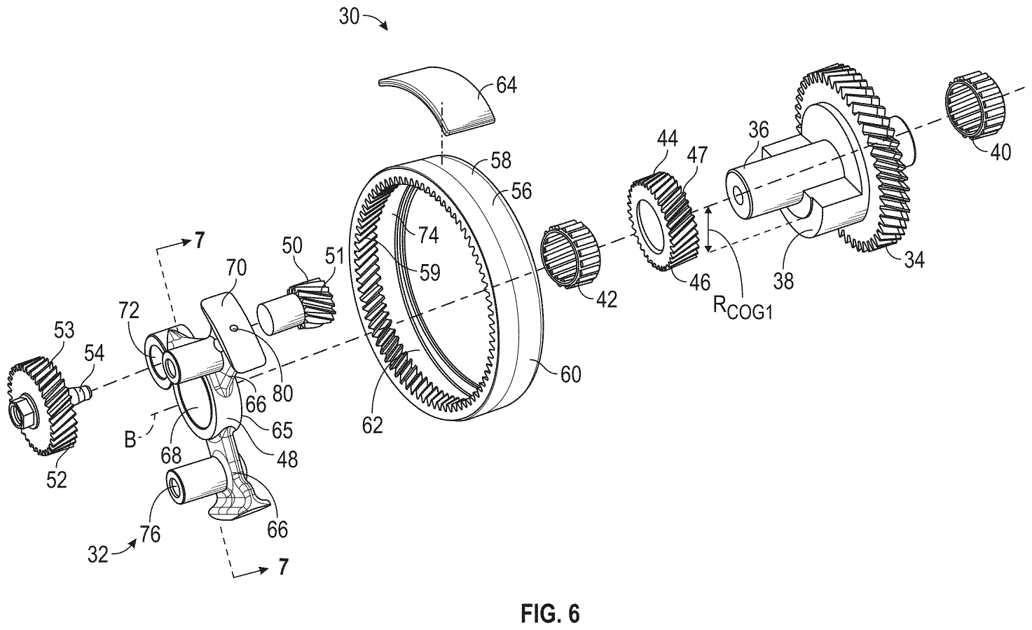

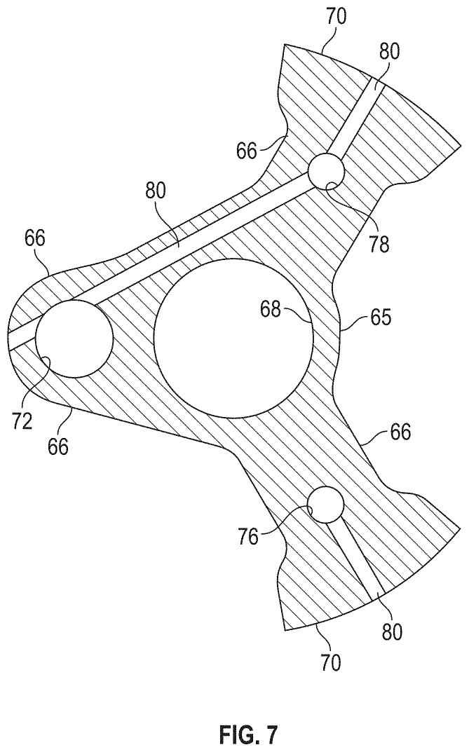

With reference to FIGS. 6 and 7, the planet carrier 48 includes a central hub 65 and a plurality of protrusions 66 extending from the central hub 65. The central hub 65 defines a central hole 68 configured, sized, and shaped to receive the second roller bearing 42 and part of the balance shaft 36. Accordingly, the planet carrier 48 supports the balance shaft 36. One or more of the protrusions 66 defines sliding surfaces 70 to allow the ring gear 58 to slide relative to the planet carrier 48. In the depicted embodiment, solely two of the protrusions 66 define the sliding surfaces 70. The inner ring surface 62 includes a smooth, guiding portion 74 that receives the sliding surfaces 70 of the planet carrier 48, thereby guiding the rotation of the ring gear 58 relative to the planet carrier 48. In the depicted embodiment, one of the protrusions 66 defines a housing 72 (i.e., void) configured, shaped, and sized to receive the fastener 54 and part of the first planet gear 50. One of the protrusions 66 defines a fastening hole 76 configured, shaped, and sized to receive a connecting fastener to fix the planet carrier 48 to the engine block 12. Another of the protrusions 66 defines an oil pickup hole 78 configured to receive oil to facilitate lubrication of the in-line balance shaft system 30. The planet carrier 48 defines a plurality of channels 80 configured to receive oil to facilitate lubrication of the in-line balance shaft system 30.

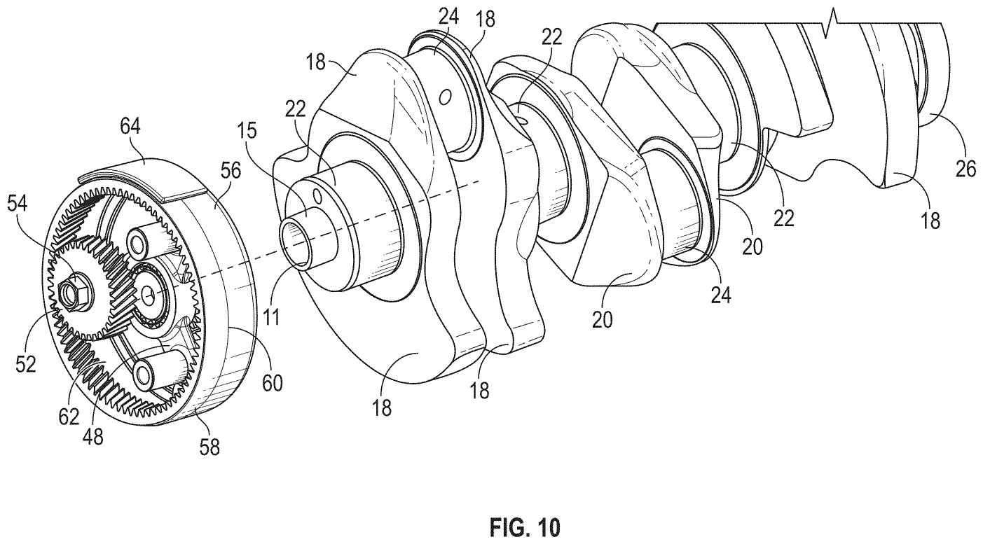

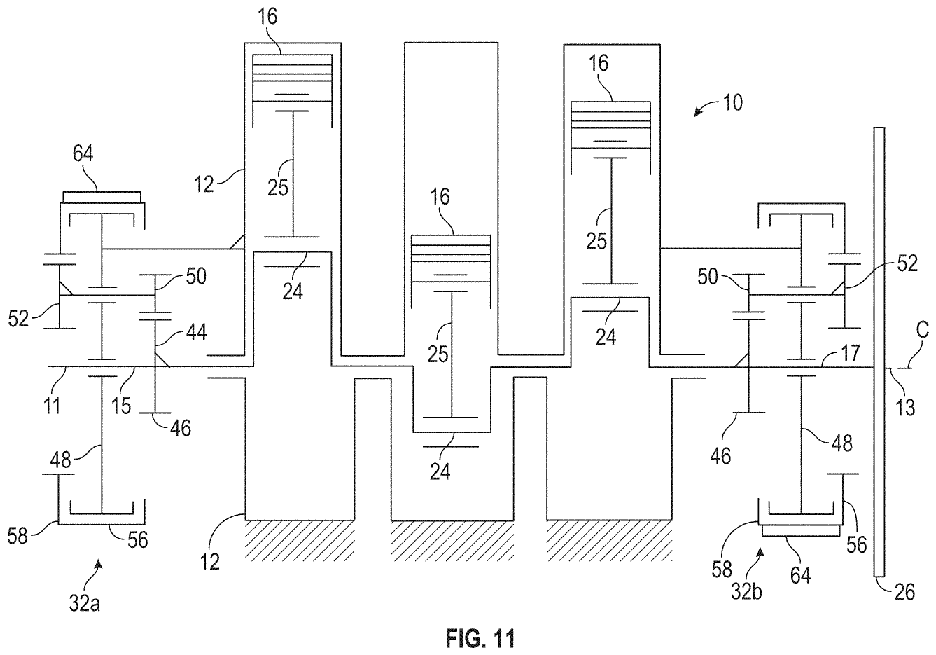

With reference to FIGS. 9-11, the in-line balance shaft system 30 may be used with an internal combustion engine 10 that is configured as a 4-cylinder engine. In this embodiment, the in-line balance shaft system 30 includes a first planetary gear set 32a and a second planetary gear set 32b both of which are identical to the planetary gear set 32 described above. In the interest of brevity, solely the differences between the embodiment described in FIGS. 1-9 and this embodiment are described in detail herein. In this embodiment, the first planetary gear set 32a is directly coupled to the first end portion 15 of crankshaft 14, and the second planetary gear set 32b is directly coupled to a second end portion 17 of crankshaft 14 to balance the internal combustion engine 10. The the first planetary gear set 32a and the second planetary gear set 32b are spaced apart from each other along the crankshaft axis C. The input gear 44 (e.g., sun gear 46) of each of the first planetary gear set 32a and the second planetary gear set 32b is configured to rotate about the crankshaft axis C. The crankshaft 14 includes a forwardmost end 11 and a rearmost end 13 opposite the forwardmost end 11. The first end portion 15 includes the forwardmost end 11 of the crankshaft 14, and the second end portion 17 includes the rearmost end 13 of the crankshaft 14. The first planetary gear set 32a is closer to the forwardmost end 11 than to the rearmost end 13 of the crankshaft 14, and the second planetary gear set 32a is closer to the rearmost end 13 than to the forwardmost end 11 of the crankshaft 14 to balance the internal combustion engine 10. In this embodiment, the in-line balance shaft system 30 does not include the balance shaft gear 34, the balance shaft 36, and the shaft counterweight 38. The arrangement of the first planetary gear set 32a and the second planetary gear set 32b on opposite end portions (i.e., the first end portion 15 and the second end portion 17) of the crankshaft 14 are enough to balance the internal combustion engine 10.

While the best modes for carrying out the disclosure have been described in detail, those familiar with the art to which this disclosure relates will recognize various alternative designs and embodiments for practicing the disclosure within the scope of the appended claims.

What is claimed is:

1. An internal combustion engine, comprising:
a crankshaft including an outer crankshaft gear;
an in-line balance shaft system coupled to the crankshaft, wherein the in-line balance shaft system is configured to provide concurrent and counter-rotating balance forces to balance reciprocating inertial forces of the internal combustion engine, and the in-line balance shaft system includes:
a planetary gear set coupled to the crankshaft, wherein the planetary gear set is coupled to the outer crankshaft gear such that rotation of the crankshaft drives the planetary gear set, and the planetary gear set includes:
an input gear, wherein the input gear is coupled to the crankshaft such that rotation of the crankshaft causes rotation of the input gear;
an output gear, wherein the planetary gear set is configured to provide a 1:1 gear ratio between the input gear and the output gear such that the input gear and the output gear rotate at a same speed upon rotation of the crankshaft; and
a gear counterweight coupled to the output gear, wherein the gear counterweight is configured to balance the crankshaft upon rotation of the crankshaft.

2. The internal combustion engine of claim 1, wherein the in-line balance shaft system includes a balance shaft gear, and the outer crankshaft gear is meshed with the balance shaft gear such that rotation of the crankshaft causes rotation of the balance shaft gear.

3. The internal combustion engine of claim 2, wherein the in-line balance shaft system includes a balance shaft coupled to the balance shaft gear such that the balance shaft rotates in unison with the balance shaft gear, the crankshaft includes a plurality of crankshaft counterweights, the outer crankshaft gear is coupled to at least one of the plurality of crankshaft counterweights such that the outer crankshaft gear rotates in unison with the plurality of crankshaft counterweights, the crankshaft rotates about a crankshaft axis, the balance shaft rotates about a balancer axis, the crankshaft axis is offset from the balancer axis, and the balancer axis is parallel to the crankshaft axis, the outer crankshaft gear is configured to rotate about the crankshaft axis, the balance shaft gear is configured to rotate about the balancer axis, and the internal combustion engine is a 4-cylinder engine.

4. The internal combustion engine of claim 3, wherein the in-line balance shaft system further includes a shaft counterweight directly coupled to the balance shaft gear such that rotation of the balance shaft gear causes rotation of the shaft counterweight, and the gear counterweight is directly coupled to the output gear.

5. The internal combustion engine of claim 4, wherein the input gear is a sun gear, the balance shaft is directly coupled to the sun gear such that rotation of the balance shaft causes rotation of the sun gear, and the sun gear is configured to rotate about a second rotational axis.

6. The internal combustion engine of claim 5, wherein the planetary gear set includes a first planet gear meshed with the sun gear such that rotation of the sun gear causes the first planet gear to orbit around the sun gear.

7. The internal combustion engine of claim 6, wherein the planetary gear set includes a planet carrier coupled to the first planet gear, the internal combustion engine includes an engine block, and the planet carrier is coupled to the engine block such that the planet carrier remains stationary upon rotation of the sun gear and the first planet gear.

8. The internal combustion engine of claim 7, wherein the planetary gear set includes a second planet gear coupled to the first planet gear such that the first planet gear and the second planet gear rotate in unison.

9. The internal combustion engine of claim 8, wherein the output gear is a ring gear, the ring gear is meshed with the second planet gear such that rotation of the second planet gear causes rotation of the ring gear, thereby causing the sun gear and the ring gear to rotate in opposite directions.

10. The internal combustion engine of claim 9, wherein the gear counterweight is directly coupled to the ring gear to provide a counter-rotating balance force to the ring gear, and the ring gear is configured to rotate about the second rotational axis.

11. An internal combustion engine, comprising:
a crankshaft defining a crankshaft axis, wherein the crankshaft includes a first end portion and a second end portion opposite the first end portion, the second end portion is spaced apart from the first end portion along the crankshaft axis, and the crankshaft is configured to rotate about the crankshaft axis;
an in-line balance shaft system coupled to the crankshaft, wherein the in-line balance shaft system is configured to provide concurrent and counter-rotating balance forces to balance reciprocating inertial forces of the internal combustion engine, and the in-line balance shaft system includes:
a first planetary gear set coupled to the first end portion of the crankshaft;
a second planetary gear set coupled to the second end portion of the crankshaft such that the first planetary gear set and the second planetary gear set are spaced apart from each other along the crankshaft axis;
wherein each of the first planetary gear set and the second planetary gear set includes:
an input gear, wherein the input gear is coupled to the crankshaft such that rotation of the crankshaft causes rotation of the input gear;
an output gear, wherein each of the first planetary gear set and the second planetary gear set is configured to provide a 1:1 gear ratio between the input gear and the output gear such that the input gear and the output gear rotate at a same speed upon rotation of the crankshaft; and
a gear counterweight coupled to the output gear, wherein the gear counterweight is configured to balance the crankshaft upon rotation of the crankshaft.

12. The internal combustion engine of claim 11, wherein the input gear is a sun gear, and the crankshaft is directly coupled to the sun gear such that rotation of the crankshaft causes rotation of the sun gear.

13. The internal combustion engine of claim 12, wherein each of the first planetary gear set and the second planetary gear set includes a respective first planet gear meshed with the sun gear such that rotation of the sun gear causes the first planet gear to orbit around the sun gear.

14. The internal combustion engine of claim 13, wherein the sun gear of each of the first planetary gear set and the second planetary gear set is configured to rotate about the crankshaft axis, the crankshaft includes a forwardmost end and a rearmost end opposite the forwardmost end, the first end portion includes the forwardmost end of the crankshaft, the second end portion includes the rearmost end of the crankshaft, the first planetary gear set is closer to the forwardmost end than to the rearmost end of the crankshaft, the second planetary gear set is closer to the rearmost end than to the forwardmost end of the crankshaft, and the internal combustion engine is a 3-cylinder engine.

15. The internal combustion engine of claim 14, wherein each of the first planetary gear set and the second planetary gear includes a planet carrier coupled to the first planet gear, the internal combustion engine includes an engine block, and the planet carrier is coupled to the engine block such that the planet carrier remains stationary upon rotation of the sun gear and the first planet gear.

16. The internal combustion engine of claim 15, wherein each of the first planetary gear set and the second planetary gear set includes a respective second planet gear coupled to the first planet gear such that the first planet gear and the second planet gear rotate in unison.

17. The internal combustion engine of claim 16, wherein the output gear is a ring gear, the ring gear is meshed with the second planet gear such that rotation of the second planet gear causes rotation of the ring gear, thereby causing the sun gear and the ring gear to rotate in opposite directions.

18. The internal combustion engine of claim 17, wherein the gear counterweight is directly coupled to the ring gear to provide a counter-rotating balance force.

19. An in-line balance shaft system configured to be coupled to a crankshaft of an internal combustion engine, comprising:
a planetary gear set coupled to the crankshaft, wherein the planetary gear set includes:
a sun gear, wherein the sun gear is coupled to the crankshaft such that rotation of the crankshaft causes rotation of the sun gear;
a ring gear, wherein the planetary gear set is configured to provide a 1:1 gear ratio between the sun gear and the ring gear such that the sun gear and the ring gear rotate at a same speed upon rotation of the crankshaft; and
a gear counterweight coupled to the ring gear;
a first planet gear meshed with the sun gear such that rotation of the sun gear causes the first planet gear to orbit around the sun gear;
a second planet gear coupled to the first planet gear such that the first planet gear and the second planet gear rotate in unison, wherein the ring gear is meshed with the second planet gear such that rotation of the second planet gear causes rotation of the ring gear, thereby causing the sun gear and the ring gear to rotate in opposite directions;
a balance shaft gear configured to mesh with an outer crankshaft gear of the crankshaft such that rotation of the crankshaft causes rotation of the balance shaft gear;
a balance shaft coupled to the balance shaft gear such that the balance shaft rotates in unison with the balance shaft gear; and
a shaft counterweight directly coupled to the balance shaft gear such that rotation of the balance shaft gear causes rotation of the shaft counterweight.

20. The in-line balance shaft system of claim 19, wherein the gear counterweight is directly coupled to the ring gear to provide a counter-rotating balance force, wherein the balance shaft is directly coupled to the sun gear such that rotation of the balance shaft causes rotation of the sun gear, wherein the gear counterweight is configured to balance the crankshaft upon rotation of the crankshaft, the planetary gear set includes a planet carrier coupled to the first planet gear, wherein the planet carrier is configured to remain stationary upon rotation of the sun gear and the first planet gear,
the in-line balance shaft system is configured to balance reciprocating inertial forces of the internal combustion engine, the in-line balance shaft system is configured to provide concurrent and counter-rotating balance forces.
